(19) United States
(12) Patent Application Publication
(10) Pub. No.: US 2003/0061614 A1
(43) Pub. Date: Mar. 27, 2003

(54) High-speed point-to-point modem-less microwave radio frequency link using direct on-off key modulation

(75) Inventors: Kenneth R. Wood, Hadley, MA (US); Christopher T. Koh, South Deerfield, MA (US); Myung K. Lee, South Deerfield, MA (US); Eric L. Holzman SR., Sunderland, MA (US); Wayne E. Pleasant, Turners Falls, MA (US)

Correspondence Address: David J. Thibodeau, Jr., HAMILTON, BROOK, SMITH & REYNOLDS, P.C., Two Militia Drive, Lexington, MA, 02421-4799, US

(73) Assignee: Telaxis Communications Corporation, South Deerfield, MA

(21) Appl. No.: 09/961,801

(22) Filed: Sep. 24, 2001

(51) Int. Cl. H04H 1/00; H04N 7/20

(52) U.S. Cl. 725/73; 455/3.01; 455/3.05

(57) ABSTRACT

A point-to-point microwave radio link that operates in a Frequency Division Duplex (FDD) mode using direct digital modulation with an ON-OFF Keyed (OOK) scheme. The transmit signal is generated by a circuit that uses an oscillator operating in a microwave radio band. The oscillator output is switched at the input bit rate. The output of the switched oscillator is then frequency multiplied by the predetermined factor to produce the modulated microwave output signal at the desired band.

### BACKGROUND OF THE INVENTION

The need to transport high-bandwidth signals from place to place continues to drive growth in the telecommunications industry. As the demand for high-speed access to data networks, including both the Internet and private networks, continues to evolve, network managers face an increasing need to transport data signals over short distances. For example, in corporate campus environments, it is often necessary to implement high-speed network connections between buildings rapidly and inexpensively, without incurring commitments for long-term service contracts with local telephone companies. Other needs occur in residential areas, including apartment buildings, and even private suburban neighborhoods. Each of these settings requires efficient distribution of high-speed data signals to a number of locations.

An emerging class of products provides a broadband wireless access solution via point-to-point communication links over radio carrier frequencies in the microwave radio band. The telecommunications transport signals may be provided on a wire, but increasingly, these are provided on optical fiber media. An optical to electrical conversion stage is thus first required to convert the baseband digital signal. Next, a microwave frequency radio is needed to up-convert the broadband digital signal to a suitable radio carrier frequency. These up-converters are typically implemented using multi-stage heterodyne receivers and transmitters such that the input baseband signal is modulated and then up-converted to the desired radio frequency. For example, in the case of an OC-3 rate optical transport signal having a bandwidth of 155 MegaHertz (MHz), the input signal may be up converted to an ultimate microwave carrier of, for example, 23 GHz, through several Intermediate Frequency (IF) stages at lower radio frequencies.

Other implementations may use optical technologies to transport the signal over the air. These technologies use optical emitters and detectors operating in the high infrared range. While this approach avoids conversion of the optical input to an electrical signal, it has certain limitations. First, the light wave carrier has a narrow beamwidth, meaning that the transmitter and receiver must be carefully aligned with one another. Light wave carriers are also more susceptible to changes in physical conditions. These changes may be a result of changes in sunlight and shade exposure, or foreign material causing the lenses to become dirty over time. Other problems may occur due to vibrations from nearby passing automobiles and heating ventilating and cooling equipment. Some members of the public are concerned with possible eye damage from high powered lasers.

### SUMMARY OF THE INVENTION

The present invention is a point-to-point microwave radio link that operates in a Frequency Division Duplex (FDD) mode using separate microwave band radio frequency carriers for each direction. The transmitter uses direct digital modulation to convert an input baseband optical rate signal to the desired microwave frequency carrier. The design may be targeted for operation at unallocated frequencies in the millimeter wave spectrum, such from 40-320 GHz.

The direct digital modulation mechanism is implemented using an ON-OFF Keyed (OOK) scheme. The OOK signal is generated at the transmitter by a circuit that uses a stable oscillator operating in the Ku microwave band. The oscillator RF output is switched on and off using a high speed switch. For very high data rates, a mixer can provide the needed switching times. The switched oscillator output is fed to a frequency multiplier that multiplies the modulated microwave signal output to a higher output carrier frequency. For example, where it is desired to generate an output microwave signal in the 48-52 GHz range for a OC-3 input optical signal, the frequency multiplier may multiply the oscillator output by a factor of four. A bandpass filter and power amplifier then feed a final stage filter and antenna.

The receiver uses an inverse signal chain consisting of a microwave oscillator, frequency multiplier, and bandpass filter. A single down conversion stage is all that is required. By inserting the frequency multiplier between the oscillator and down convertor mixer, the local oscillator remains offset by a wide margin from the input RF carrier frequency. This permits the receiver image reject filters to be implemented more easily.

While the direct digital modulation approach is not necessarily bandwidth-efficient, it provides a low cost alternative to traditional approaches, since the base band modem and multiple RF stages are eliminated. Because there are no heterodyne stages, there also are no images of the modulated baseband signals created on either side of the carrier frequency. Thus, image reject filters are not necessary.

### BRIEF DESCRIPTION OF THE DRAWINGS

FIG. 1 is a block diagram of a point-to-point, optical to microwave link according to the invention.

FIG. 2 is a detailed circuit diagram of an ON-OFF Keyed (OOK) transmitter used in the link.

FIG. 3 is a detailed circuit diagram of an OOK receiver.

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

### DETAILED DESCRIPTION OF THE INVENTION

A description of preferred embodiments of the invention follows.

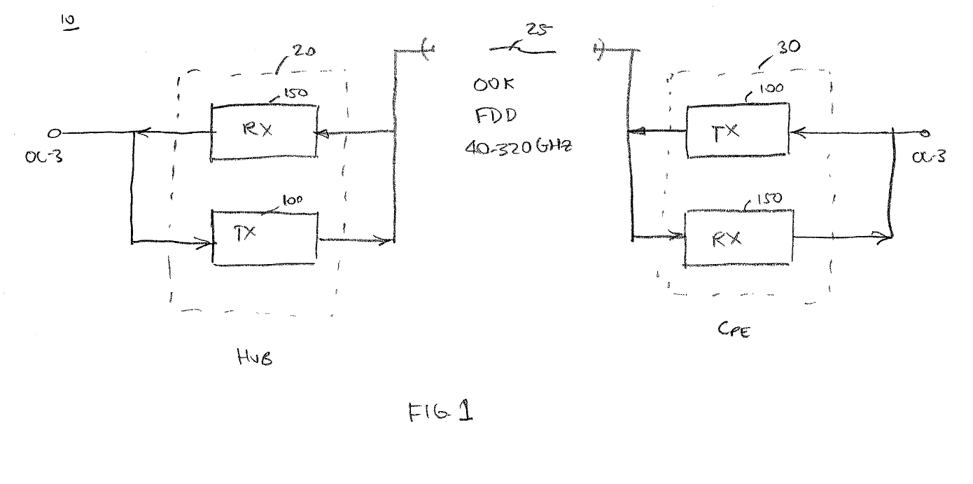

FIG. 1 is a block diagram of a point-to-point wireless communications system that may make use of a direct conversion transmitter and receiver according to the invention. The system 10 includes at least a pair of optical-to-microwave link interfaces 20, 30. A first optical-to-microwave link interface may be located, for example, at a central location such as a Network Access Point (NAP) 20 that provides connections to a data network. In the illustrated example, the network connection is provided from an optical fiber that carriers a transport signal modulated in accordance with the OC-3 standard signaling format. The OC-3 optical signal carries an information signal having a data rate of 155.22 Megabits per second (Mbps). A similar optical-to-microwave converter unit 30 is located at another remote location, such as a Network Termination Point (NTP). The unit 30 also provides connectivity to a similar OC-3 optical transport connection. The units 20, 30 may, for example, be located on the roofs of buildings in a campus environment to which it is desired to provide high-speed network connections between buildings.

In any event, both units 20 and 30 each have a transmitter 100 and receiver 150. The transmitter 100 and receivers 150 operate in a Frequency Division Duplex (FDD) mode, such that transmitter-receiver pairs operate on distinct carrier frequencies. For example, in a downlink direction from unit 20 towards unit 30, the transmitter 100 in unit 20 operates on the same microwave carrier frequency to which the receiver 100 in unit 30 is tuned. Likewise, the receiver 150 in unit 20 is tuned to the microwave carrier which the transmitter 100 in unit 30 operates.

Acceptable operating frequencies for the uplink and downlink may be in an unlicensed microwave band. For example, in the United States, appropriate unlicensed microwave radio bands occur in the various regions of the 40 to 320 GHz band.

It should be understood that the units 20 and 30 may be deployed at any short haul point-to-point locations, such that the specific locations are in effect network peers. It should also be understood that the invention may be used to carry data traffic between different types of locations and different types of network traffic.

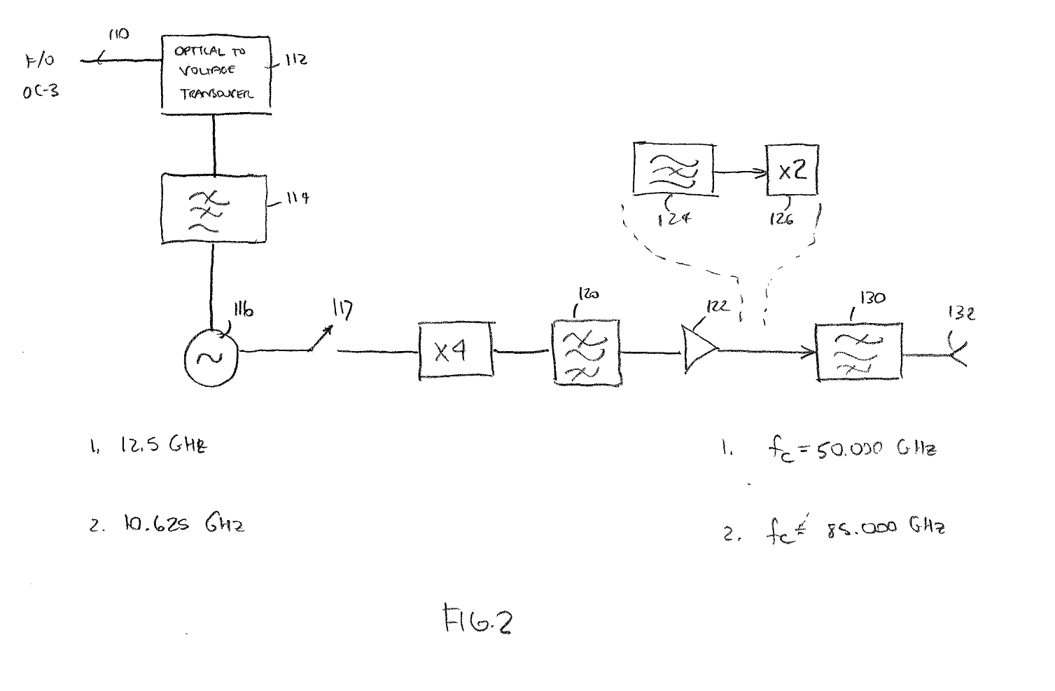

Turning attention now to FIG. 2, an exemplary transmitter 100 will be described in greater detail. The transmitter 100 includes an optical to voltage transducer 112, a baseband filter 114, a direct modulator 116, a multiplier 118, a bandpass filter 120, a buffer amplifier 122, an output waveguide filter 130, and a transmit antenna 132. Optionally, a second-stage bandpass filter 124 and multiplier 126 may be utilized. The illustrated implementation is for an ON-OFF Keyed (OOK) implementation.

In operation, the input OC-3 formatted optical signal is fed to the optical to voltage transducer 112. The transducer 112 produces at its output a raw transport bitstream. For an input optical signal of the OC-3 format, the transport bitstream is a digital signal at a 155.22 Mbps rate. The raw transport bitstream is then fed to a lowpass filter 114 to remove any artifacts of the optical to voltage conversion process. It should be understood that other digital input signal types may be supported, such as OC-1, OC-12 or other optical range transport signals.

The oscillator 116 is perferably a phase-locked fixed frequency oscillator in combination with a high speed switch. The switch 117 implements ON-OFF Key (OOK) type modulation shifting to, for example, switch off to indicate a zero data bit and switch on to indicate a one data bit. The oscillator is implemented such that it preserves a continuous phase during the data shifts. The continuous phase nature of the oscillator further relaxes the requirements on the following filters 120, 130 and buffer amplifier 122.

After being converted to a voltage from the optical carrier, the input baseband signal is directly fed to the control input of the switch 117.

The oscillators used in the oscillator 116 are not particularly narrow band or stable at high operating frequencies in the 40 GHz and above range. Thus, the approach here is to use a more stable oscillator 116 source at a lower range, such as in the Ku Band, and then to rely upon the multiplier 118 to shift the oscillator output up to the desired operating band.

The output of the multiplier 118 is a frequency-deviated signal carrying the digital information by the microwave frequency carrier in the desired unlicensed band. In the illustrated embodiment (number 1), this carrier is 50.000 Ghz, meaning that the oscillator 116 is centered at 12.5 GHz.

This raw microwave signal is then fed to the first-stage bandpass filter 120 to remove artifacts of the direct modulation process.

A medium range buffer amplifier 122 then receives the filtered signal and forwards it to an output waveguide filter 130.

The waveguide filter 130 further reduces the harmonics of the oscillator 116. It need not be an image-reject filter. Such image-reject filters, if they were needed, would further increase the cost. Elimination of the heterodyne stages, while not providing as bandwidth efficient an approach, does produce a less expensive radio.

Optionally, a second-stage multiplier 126 and a bandpass filter 124 may be included for operation at higher frequencies, such as in the 81 to 87 GHz band. In example 2, the microwave carrier is 856 GHz, generated from a 10.625 GHz VCO.

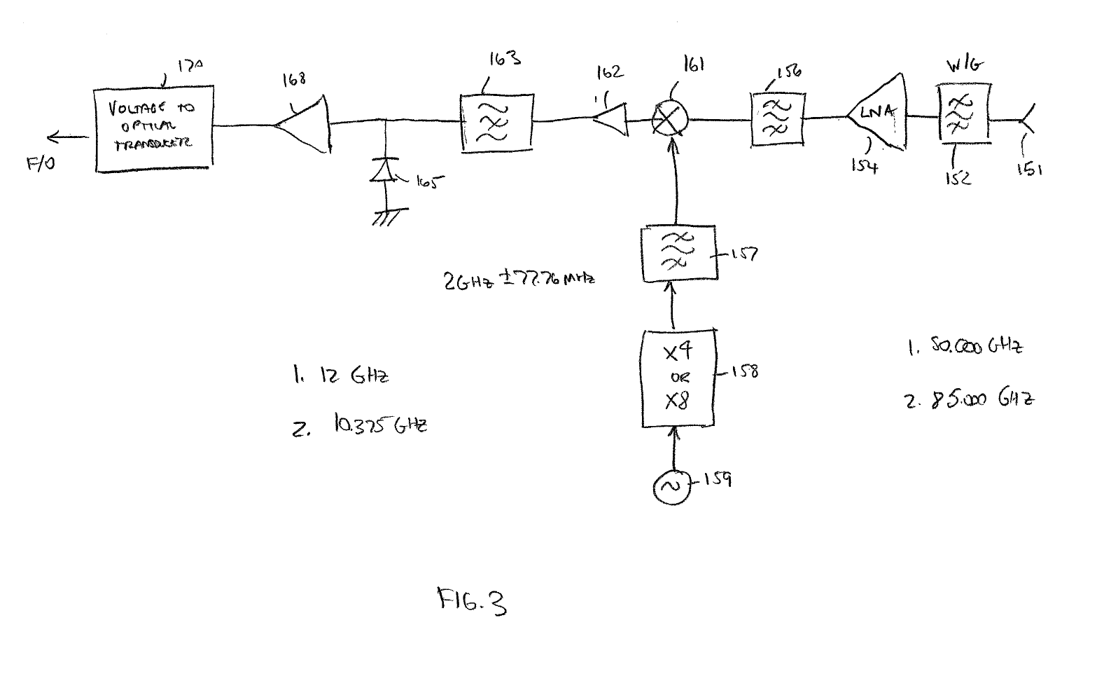

Turning attention now to FIG. 3, an exemplary receiver 150 will be described in greater detail. This receiver includes a receiving antenna 150, input waveguide filter 152, low-noise amplifier 154, bandpass filter 156, local reference generator 160, mixer 161, buffer amplifier 162, a bandpass filter 163 and associated detectors 165 and 167, an amplifier 168 and voltage-to-optical transducer 170.

The input signal provided to the receiving antenna 150 is fed to the waveguide filter 152. This filter, having a center frequency in the 50 or 85 GHz range, as the case may be, filters the desired signal from the surrounding background information.

The low-noise amplifier 154 may be implemented as a Monolithic Microwave Integrated Circuit (MMIC) feeding a planar bandpass filter in the 50 or 85 GHz range. The low noise amplifier typically has a 6-8 decibel (dB) noise figure and provides 10-20 dB of gain. The secondary filter 156 may be implemented as needed prior to the down-converter mixer stage 161.

The local oscillator reference generator 160 consists of a 12.5 GHz or 10.375 GHz oscillator 157, frequency multiplier 158 and bandpass filter 159. The order of components is identical to that used in the transmitter, namely the modulator 116, multiplier 118, and bandpass filter 120.

The down-converter 161 uses a single mixer that provides the baseband information to a buffer amplifier 162. Thus, the resulting signal is the basic raw 155.52 MHz information modulated onto the microwave carrier output. The bandpass filter 163 is tuned to receive the frequency bandwidth of the modulated carrier.

The detector diode 165 provides an output indication when energy is present in the output of the bandpass filter 163. This detected signal is then fed to the amplifier 168 to provide a resulting digital signal. This is then fed to the voltage-to-optical transducer 170 to reconstruct the OC-3 format optical transport signal.

Down-conversion directly to the relatively high IF of 2 GHz provides for a simpler discriminator implementation, i.e., the bandpass filter may be at a microwave frequency rather than at baseband. This results from the fact that the resulting local oscillator signal fed to the down-convertor mixer 161 is offset from the RF carrier by 2 GHz, and ensures that it is easier to reject images in the bandpass filter 163.

The invention, therefore, provides for direct modulation of the input bitstream utilizing ON-OFF keying. No manipulation of the bitstream is required such as in the case of baseband modulation. Furthermore, because of the direct up-conversion to the desired microwave frequency carrier, multiple heterodyne stages are eliminated. Heterodyne stages, while providing for efficient filtering topologies, create interference and spurious noise problems, as well as increased cost in overall implementation.

While this invention has been particularly shown and described with references to preferred embodiments thereof, it will be understood by those skilled in the art that various changes in form and details may be made therein without departing from the scope of the invention encompassed by the appended claims.

What is claimed is:

1. A transport to microwave radio frequency adapter that accepts an input telecommunications transport signal on an input port and converts information in such signal to a desired microwave Radio Frequency (RF) carrier, the input transport signal carrying information at an input bit rate, the apparatus comprising:
an oscillator, coupled to receive the transport signal, a switch implementing an ON-OFF keyed modulation such that the on-state is selected to indicate a first logical value for an input data bit in the transport signal and the off-state is selected to indicate a second logical value for an input data bit in the transport signal, the switch rate selected to be equal to the input bit rate; and
a frequency multiplier connected to receive the output of the switched oscillator and to multiply the output of the switched oscillator to the desired microwave RF carrier.

2. An apparatus as in claim 1 wherein the telecommunications transport signal is provided on an optical physical medium.

3. An apparatus as in claim 2 additionally comprising:
an optical-to-voltage transducer connected to receive the telecommunications signal and to provide a baseband electrical signal at an output.

4. An apparatus as in claim 1 wherein the frequency multiplier is implemented in a plurality of frequency multiplication stages.

5. An apparatus as in claim 1 wherein the oscillator, switch and frequency multiplier perform a direct conversion of the input transport signal to the microwave RF carrier.

6. An apparatus as in claim 6 wherein the direct conversion is performed without using the input transport signal to modulate an intermediate carrier signal.

7. An apparatus as in claim 1 additionally comprising:
a microwave bandpass filter connected to the output of the frequency multiplier to filter harmonics of the carrier frequency of the oscillator.

8. An apparatus as in claim 1 additionally comprising:
a microwave RF to transport adapter, to convert a received microwave RF signal to a transport signal carrying an output telecommunications transport signal.

9. An apparatus as in claim 9 wherein the microwave RF to transport adapter further comprises:
an oscillator, operating at a carrier frequency which is a predetermined fraction of a desired direct down-conversion frequency;
a frequency multiplier, connected to receive the oscillator output, and to multiply the oscillator output up to the desired direct down-conversion frequency; and
a mixer, coupled to the frequency multiplier and the microwave RF signal, to provide a down-converted transport signal.

10. An apparatus as in claim 10 additionally comprising:
a bandpass filter, tuned to a frequency which is equal to the down-conversion frequency.

11. An apparatus as in claim 11 additionally comprising:
a detector diode, connected to the bandpass filter, and to it provide a detected signal.

12. An apparatus as in claim 12 additionally comprising;
an amplifier, connected to receive the detected signal, and to provide the output transport signal.

13. An apparatus as in claim 13 additionally comprising:
an electrical-to-optical transducer, coupled to the amplifier output, to provide an optical transport signal.
